(19) United States
(12) Patent Application Publication
(10) Pub. No.: US 2005/0188003 A1
(43) Pub. Date: Aug. 25, 2005

(54) Data transmission equipment

(75) Inventors: Mitsuo Teramura, Ichihara-shi (JP); Ichiro Kouno, Osaka (JP); Mitsuyoshi Uno, Asahikawa-shi (JP)

Correspondence Address: Fildes & Outland, P.C., Suite 2, 20916 Mack Avenue, Grosse Pointe Woods, MI, 48236, US

(73) Assignee: CONTEC CO., LTD.

(21) Appl. No.: 11/028,747

(22) Filed: Jan. 4, 2005

(30) Foreign Application Priority Data
Feb. 25, 2004 (JP) 2004-048841

(51) Int. Cl. G06F 15/16

(52) U.S. Cl. 709/200

(57) ABSTRACT

An expansion unit (peripheral device) includes a detection circuit for detecting establishment of communication between a PC card of a notebook-type personal computer and a communication board of the expansion unit, and a power supply control circuit for powering on the expansion unit in accordance with the detection of the establishment of communication by the detection circuit. The notebook-type personal computer starts up the OS as a result of being powered ON, performs recognition of the PC card in a card slot, supplies power to the PC card and, after a fixed wait time, performs recognition of a PCI board of the expansion unit via the PC card, the serial cable (communication line) and the communication board.

### BACKGROUND OF THE INVENTION

1. Field of the Invention

The present invention relates to data transmission equipment and, more particularly, to power interlocking between a main device which comprises a computer, and a peripheral device.

2. Description of the Related Art

Data transmission equipment is an equipment that performs data transmission (sends and receives data) between a main device (a computer) and a peripheral device that is connected to the main device. Such data transmission equipment includes an equipment that performs ‘power interlocking’ that turns a power supply of the peripheral device ON/OFF in tandem with the ON/OFF of the power supply of the main device. This equipment is constituted such that the main device and peripheral device are connected by means of parallel cables and, when the power supply of the main device is turned ON, a signal is transmitted by using one of a multiplicity of parallel cables such that the power supply of the peripheral device is also turned ON at substantially the same time.

However, because parallel cables are used, the cable length is limited to about one meter. This has therefore posed a problem that the main device and peripheral device must be installed within one meter of one another and the freedom of placement is reduced. As a method for resolving this problem of reduced freedom of placement, a connection using switch fabric technology between the main device and peripheral device has been considered. According to the switch fabric technology, by connecting the main device and peripheral device by means of serial cables, the distance between the main device and peripheral device can be extended to about twelve meters and the freedom for placing the peripheral device in a location apart from the main device can be raised.

However, when the freedom of placement is raised in this way, ‘power interlocking’ conversely becomes complicated. That is, due to the small number of lines the serial cables afford, one of these cables cannot be used as a line dedicated to power (a line that transmits a signal to confirm establishment of the power of the main device), and hence it is difficult to turn on the power supply simultaneously. Therefore, a power interlocking method may be considered in which a dedicated line is laid separately from the serial cable, a signal confirming establishment of the power supply of the main device is transmitted to the peripheral device via this dedicated line, the peripheral device detects this power establishment confirmation signal, and power is supplied to an installed PCI board. However, when a dedicated line is laid separately, a problem of increased costs arises.

Meanwhile, in the case of a main device composed of a notebook-type personal computer with a card slot (card bus controller), when the power supply switch is turned ON, the operating system (OS) starts up. When the OS starts up, it is confirmed whether a card is inserted in the card slot. When insertion of a card is confirmed, confirmation of whether a PC card for peripheral-device communication is inserted in the card slot follows. When a communication PC card is recognized, each substrate (PCI board) mounted in the peripheral device is then recognized. However, here, each substrate of the peripheral device must be in a standby state.

However, in the case of the above power interlocking method between a main device and a peripheral device, a power supply of the main device is turned ON, card slots (card bus controllers) are activated, a PC card for peripheral-device communication is recognized and a power supply of the peripheral device is turned ON when a connection with the peripheral-device side is established. Thereafter, each substrate (PCI board) of the peripheral device enters the standby state. Accordingly, when OS startup is completed early, a situation arises where the OS is unable to recognize each substrate of the peripheral device.

### SUMMARY OF THE INVENTION

It is an object of the present invention is to provide a data transmission equipment that allows a power supply of a peripheral device to be turned ON/OFF in tandem with ON/OFF of a power supply of a main device without laying a dedicated line, and that permits reliable recognition of the peripheral device by the main device.

In order to achieve this object, the present invention provides first and second communication devices connected via a serial communication line, respectively in the main device and the peripheral device, for performing data communication by converting parallel data to serial data. The peripheral device is further provided with a detection circuit for detecting establishment of communication between these communication devices, and a power supply control circuit for powering on expansion portions of the peripheral device in accordance with the detection of establishment of communication by the detection circuit. The computer of the main device starts up an operating system by powering on the power supply to the computer and then recognizes the first communication device and supplies power to the first communication device. Further, after a fixed wait time, the first communication device recognizes the expansion portions provided in the peripheral device via the serial communication line and the second communication device.

With such a constitution, when the operating system is started up as a result of powering on the computer, the operating system recognizes the first communication device and supplies power to the first communication device. Accordingly, when communication is established between the first and second communication devices, the establishment of communication is detected by the detection circuit and power is supplied to the expansion portions as a result of the detection of the establishment of communication. That is, power interlocking is performed. Meanwhile, when the operating system recognizes the first communication device, the expansion portions provided in the peripheral device are recognized via the first communication device, the serial communication line and the second communication device after a fixed wait time. After the powered-on expansion portions have become stable and entered a standby state so as to be able to respond to bus conditions, in accordance with the fixed wait time, a logic of the operating system to seek expansion portions operates. By this, recognition of the expansion portions of the peripheral device is executed reliably by the operating system of the main device.

### BRIEF DESCRIPTION OF THE DRAWINGS

FIG. 1 is a schematic external view of data transmission equipment according to an embodiment of the present invention;

FIG. 2 is a structural diagram of the same data transmission equipment;

FIG. 3 is a structural diagram of a PC card and a communication board of the same data transmission equipment; and

FIG. 4 is a flowchart illustrating the operation when the data transmission equipment is powered on.

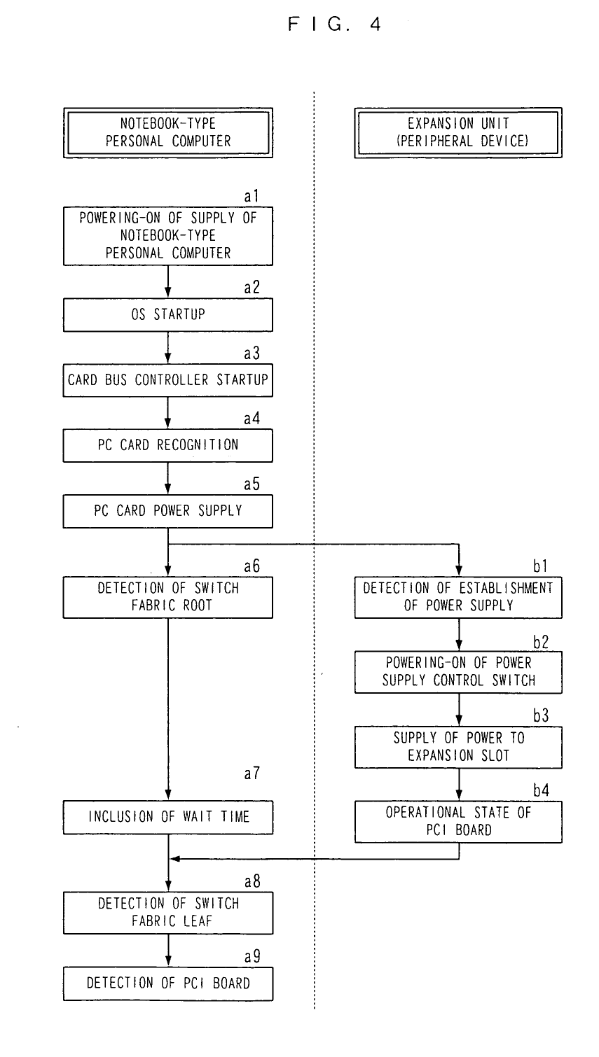

### DESCRIPTION OF THE PREFERRED EMBODIMENTS

An embodiment of the present invention will be described hereinbelow with reference to the drawings.

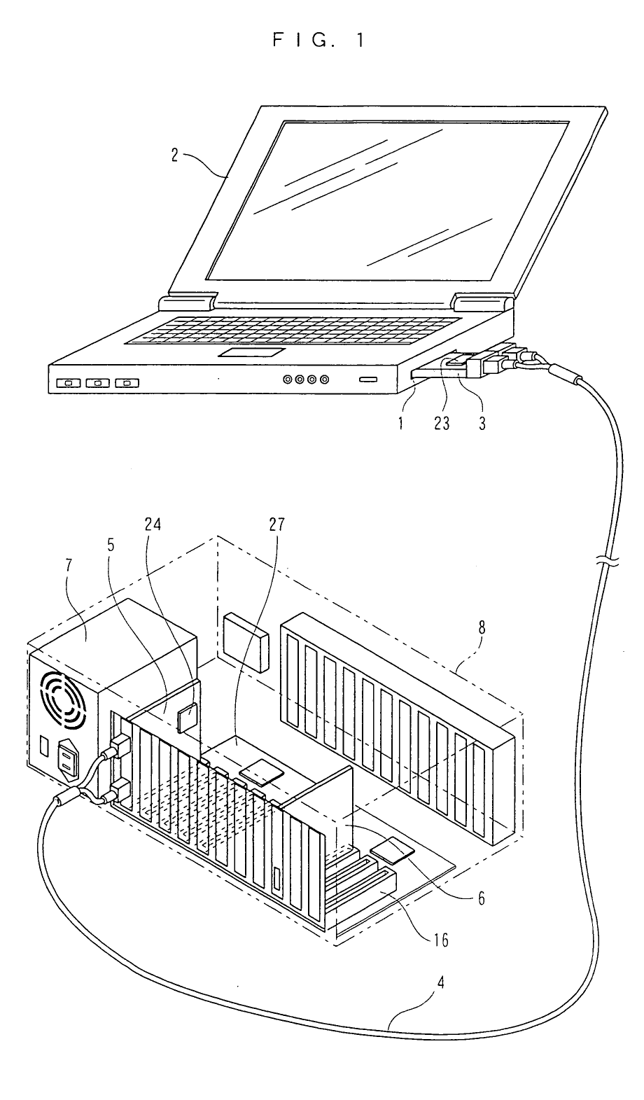

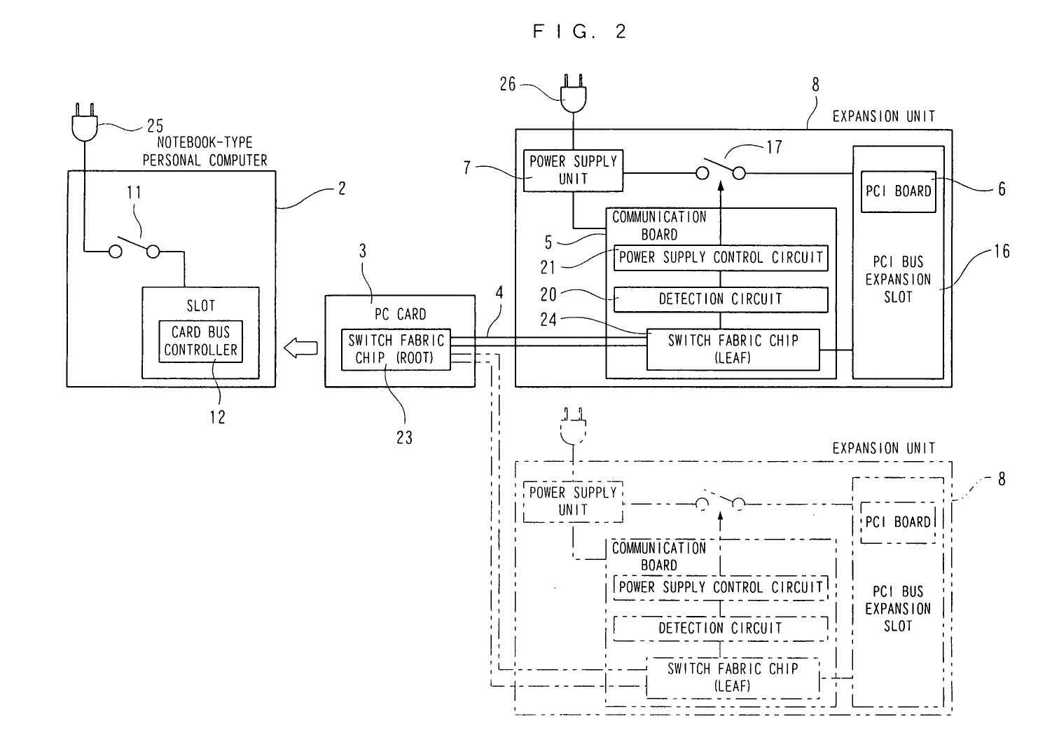

FIG. 1 is a schematic external view of the data transmission equipment of an embodiment of the present invention and FIG. 2 is a constitutional view of the same data transmission equipment.

As shown in FIGS. 1 and 2, the data transmission equipment of the present embodiment performs data transmission between a main device (notebook-type personal computer) 2 comprising a computer and having a card slot 1, and an expansion unit (an example of a peripheral device) 8. The main device will be described as a notebook-type personal computer 2 hereinbelow. Further, as indicated by the virtual lines in FIG. 2, a plurality (two in FIG. 2) of the expansion unit 8 can be connected to the notebook-type personal computer 2.

The notebook-type personal computer 2 is equipped with manipulation devices such as a liquid-crystal screen, keyboard, and so forth as shown in FIG. 1. Although such parts are not illustrated, the notebook-type personal computer 2 contains a computer that is constituted by a CPU, a memory, a controller for the liquid crystal screen, and interface circuits for the manipulation devices. The memory, liquid-crystal-screen controller, and interface circuits are connected to the CPU via a bus. Further, as shown in FIG. 2, the notebook-type personal computer 2 is provided with a power supply switch 11, and a card bus controller 12 that is supplied with power when the power supply switch 11 is turned ON. The card bus controller 12 is connected to the CPU via the bus and controls the transmission and receipt of data between the CPU and a card that is mounted in the card slot 1.

Further, the expansion unit 8 is provided with a PCI board such as a digital I/O board or analog I/O board (the substrate of the peripheral device; an example of an expansion portion that extends the functions of the main device) 6; a power supply unit 7 that converts AC power to DC power, a main substrate 27 that comprises an expansion slot 16 in which the PCI board 6 is mounted; and a power supply control switch 17 that supplies DC power to the PCI board 6 via the main substrate 27 and expansion slot 16 by means of the power supply unit 7.

Further, as the main constituents of the data transmission equipment, a PC card (an example of the first communication device) 3, a serial cable (UTP cable; an example of the serial communication line) 4, and a communication board (an example of the second communication device) 5 are provided.

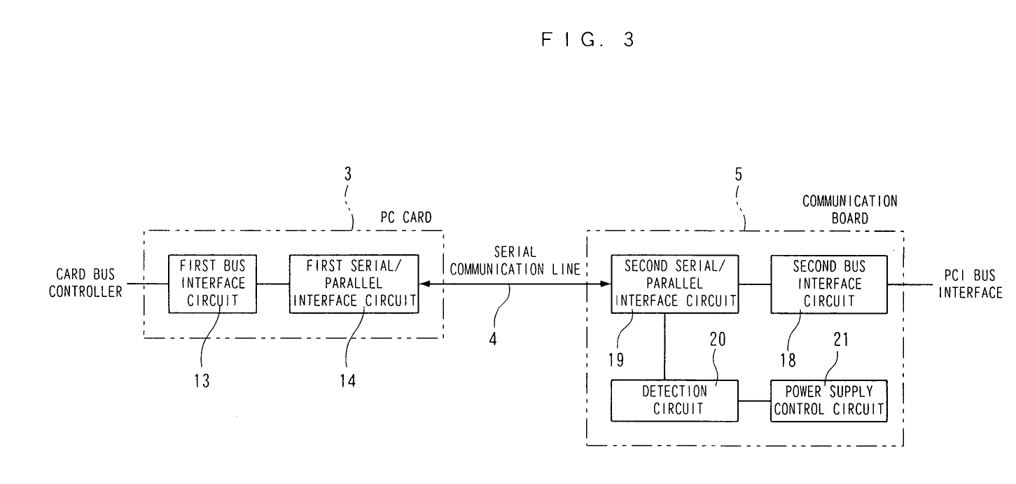

The PC card 3 is a card-type communication substrate that performs parallel-to-serial conversion of transmitted data that is transmitted from the computer of the notebook-type personal computer 2 to the PCI board 6 of an expansion unit 9 and performs serial-to-parallel conversion of received data that the computer of the notebook-type personal computer 2 receives from the PCI board 6 of the expansion unit 9. The PC card 3 is mounted in the card slot 1 of the notebook-type personal computer 2. Further, a first bus interface circuit 13 and a first serial/parallel interface circuit 14 are mounted on the PC card 3 as shown in FIG. 3.

The first bus interface circuit 13 performs acts as a bus interface with the card bus controller 12 of the notebook-type personal computer 2.

The first serial/parallel interface circuit 14 is connected between the first bus interface circuit 13 and a serial cable 4, performs parallel-to-serial conversion of transmitted data, performs serial-to-parallel conversion of received data and executes data communication.

The communication board 5 is a communication substrate that performs parallel-to-serial conversion of transmitted data that is transmitted from the PCI board 6 of the expansion unit 8 to the computer of the notebook-type personal computer 2 and performs serial-to-parallel conversion of received data that the PCI board 6 of the expansion unit 8 receives from the computer of the notebook-type personal computer 2. The communication board 5 is mounted in the expansion unit 8 and is connected to the PC card 3 via the serial cable 4. Further, as shown in FIG. 3, a second bus interface circuit 18, a second serial/parallel interface circuit 19, a detection circuit 20, and a power supply control circuit 21 are mounted on the communication board 5.

The second bus interface circuit 18 acts as a bus interface with the PCI board 6.

The second serial/parallel interface circuit 19 is connected between the serial cable 4 and the second bus interface circuit 18, performs parallel-to-serial conversion of transmitted data, performs serial-to-parallel conversion of received data and executes data communication.

The detection circuit 20 is connected to the second serial/parallel interface circuit 19 and detects establishment of communication between the PC card 3 and the communication board 5.

The power supply control circuit 21 turns ON the power supply control switch 17 in accordance with the detection of the establishment of communication by the detection circuit 20 and thus powers on the PCI board 6.

Further, in FIGS. 1, 23 and 24 each denote switch fabric chips (root/leaf) that are mounted on the PC card 3 and communication board 5 respectively. The first serial/parallel interface circuit 14 and second serial/parallel interface circuit 19 form a switch fabric bridge such as StarFabric bridge (“StarFabric” is a trademark).

Further, in FIG. 2, 25 is an AC electrical outlet for the notebook-type personal computer 2 and is connected to the power supply switch 11. Further, 26 is an AC electrical outlet for an expansion unit 7 and is connected to the power supply unit 7. DC power (standby power) is usually supplied to the communication board 5 by the power supply unit 7.

Further, because there is no signal of the establishment of communication itself in the communication signals between the switch fabric chips 23 and 24, the detection circuit 20 defines the communication signals to make conditions and detect the establishment of communication.

The operation of the notebook-type personal computer 2 and the expansion unit 8 with the above constitutions will now be described.

As preparation, the PC card 3 and communication board 5 are connected by means of the serial cable 4 and the PC card 3 is inserted in the card slot 1 of the notebook-type personal computer 2. Thereafter, power is supplied from the AC electrical outlets 25, 26 to the notebook-type personal computer 2 and the expansion unit 8 respectively. Here, DC power is supplied by the power supply unit 7 to the communication board 5 of the expansion unit 8 to operate the second bus interface circuit 18 and second serial/parallel interface circuit 19. However, the DC power is not supplied to the PCI board 6 and therefore the expansion unit 8 is in a non-functional state.

When the power supply switch 11 of the notebook-type personal computer 2 is turned ON (step a1), the operating system (OS) of the notebook-type personal computer 2 is started up (step a2). Thereafter, the card bus controller 12 is started up by the OS (step a3) and it is recognized by the OS that a card is inserted in the card slot 1 via the card bus controller 12 (step a4). When a card is recognized by the OS, power is supplied to the card slot 1 (step a5), whereupon the type of card is recognized (step a6).

When power is supplied to the card slot 1 and power is supplied to the PC card 3, communication is established between the first serial/parallel interface circuit 14 of the PC card 3 and the second serial/parallel interface circuit 19 of the communication board 5. Thereupon, the establishment of communication is detected by the detection circuit 20 of the communication boards 5 (step b1), the power supply control switch 17 is turned ON by the power supply control circuit 21 on the basis of the detection of the establishment of communication (step b2), and power is supplied to the PCI board 6 (step b3). The PCI board 6 is then stabilized by the supply of power and enters an operational standby state in response to bus conditions (step b4).

Meanwhile, when the OS recognizes the PC card 3 (switch fabric root), the OS waits for a predetermined time T (for one second, for example; an example of the fixed wait time) (step a7), and then, upon waiting for the predetermined time T, recognizes (detects) the communication board 5 (switch fabric leaf) via the PC card 3 and serial cable 4 (step a8) and then recognizes (detects) the PCI board 6 that is mounted in the expansion slot 16 (step a9).

According to the above steps, the OS is started up by the supply of power to the notebook-type personal computer 2. Thereafter, the PC card 3 in the card slot 1 is recognized by the OS and supplied with power, whereby communication between the first serial/parallel interface circuit 14 of the PC card 3 and the second serial/parallel interface circuit 19 of the communication board 5 is established. Thereupon, the establishment of communication is detected by the detection circuit 20, the power supply control switch 17 is turned ON by the power supply control circuit 21 on the basis of the detection of the establishment of communication, and power interlocking is thus performed between the notebook-type personal computer 2 and the expansion unit 8, which is the peripheral device. Further, the OS of the notebook-type personal computer 2 recognizes the PC card 3 and waits (delays recognition) during the predetermined time T when the OS is going to sequentially recognize (detect) the communication board 5 and the PCI board 6 that is mounted in the expansion slot 16. Therefore, power is supplied to the PCI board 6 and the OS waits until the PCI board 6 is stabile and enters an operational standby state in response to bus conditions, whereby the PCI board 6 is correctly recognized by the OS.

Further, when the power supply switch 11 of the notebook-type personal computer 2 is turned OFF, the supply of power to the PC card 3 of the notebook-type personal computer 2 is shut off and hence communication between the first serial/parallel interface circuit 14 of the PC card 3 and the second serial/parallel interface circuit 19 of the communication board 5 is no longer established. Thus, the establishment of communication is no longer detected by the detection circuit 20 of the communication board 5, the power supply control switch 17 is turned OFF by the power supply control circuit 21, the supply of power to the PCI board 6 is shut off, and power interlocking is executed. Further, the current consumed is reduced because the supply of power to the PCI board 6 is shut off and thus power interlocking is executed. The current consumed is also reduced by shutting off the supply of power to the PCI board 6.

Further, the predetermined time T is calculated by adding together the time (maximum 500 ms) until the power supply control switch 17 is turned ON and the voltage is stable and the time required to set the environment of the chip mounted on the PCI board 6, which is a maximum of 300 ms when an FPGA (Field Programmable Gate Array), for example, is installed. The predetermined time T is set to one second to afford a margin.

As mentioned earlier, according to this embodiment, the OS is started up by powering on the notebook-type personal computer 2, the PC card 3 in the card slot 1 is recognized by the OS and supplied with power and then recognition of the PCI board 6 that is mounted in the expansion unit 8 is executed via the PC card 3, serial cable 4 and communication board 5 by extending the predetermined time T. Therefore, after communication has been established between the PC card 3 and the communication board 5 and the powered-on PCI board 6 has become stable and entered the standby state so as to be able to respond to bus conditions, a logic of the OS to seek the PCI board 6. By this, the PCI board 6 of the expansion unit 8 can be reliably recognized by the notebook-type personal computer 2.

Furthermore, according to this embodiment, because the establishment of communication between the PC card 3 and communication board 5 is detected by the detection circuit 20 and the PCI board 6 is powered on, the need to lay a dedicated line that transmits a confirmation signal confirming the establishment of the power supply of the notebook-type personal computer 2 (main device) to the expansion unit 8 (peripheral device) can be dispensed with.

Further, according to this embodiment, by converting the data of the notebook-type personal computer 2 and expansion unit 8 (parallel data) into serial data and sending and receiving this data by using the serial cable 4, the distance between the notebook-type personal computer 2 and expansion unit 8 can be extended and the freedom of placement of the notebook-type personal computer 2 and expansion unit 8, particularly of the expansion unit 8, can be increased.

In addition, according to this embodiment, because the PC card 3 of the notebook-type personal computer 2 and the communication board 5 of the expansion unit 8 form a switch-fabric (StarFabric) bridge, the OS of the notebook-type personal computer 2 is able to access the expansion unit 8 and easily expand the expansion unit 8 without an awareness of the PC card 3 and the communication board 5 of the expansion unit 8 (at least one peripheral device).

Further, although a digital I/O board or analog I/O board is mounted in the peripheral device (expansion unit) as an expansion portion (PCI board) that expands the functions of the main device in this embodiment, the boards that are mounted are not limited to such I/O boards. Boards on which other functions are installed are also possible.

Moreover, although the communication board 5 is used as the second communication device in this embodiment, the present invention is not limited to the communication board 5. Card-type communication devices such as the PC card 3 can also be used. The second communication device can also be formed by directly mounting a switch fabric (StarFabric) chip on the main substrate 27 of the expansion unit 8 and providing the main substrate 27 with a connector (connection means) that connects with the serial cable 4.

Further, although the expansion unit 8 is provided as a peripheral device in this embodiment, the peripheral device is not limited to or by this expansion unit 8. A hard disk, optical disk recording/playback device or the like can also be provided. Here, the second communication device is provided in the hard disk, optical disk recording/playback device, or the like.

Moreover, according to this embodiment, the PC card 3 of the notebook-type personal computer 2 and the communication board 5 of the expansion unit 8 form a switch fabric bridge, but it may not necessarily be a switch fabric bridge. Any constitution which enables serial communication is acceptable.

1. Data transmission equipment for performing data transmission between a main device comprising a computer and having a card slot, and at least one peripheral device comprising at least one expansion portion for expanding functions of the main device, said data transmission equipment comprising:
a card-type first communication device mounted in the card slot of the main device, for performing parallel-to-serial conversion of transmitted data from the computer of the main device to the expansion portion of the peripheral device and performing serial-to-parallel conversion of received data that the computer of the main device receives from the expansion portion of the peripheral device, wherein
the peripheral device comprises:
a second communication device connected to the first communication device via a serial communication line, for performing parallel-to-serial conversion of transmitted data from the expansion portion of the peripheral device to the computer of the main device and performing serial-to-parallel conversion of received data that the expansion portion of the peripheral device receives from the computer of the main device;
a detection circuit for detecting establishment of communication between the first and second communication devices; and
a power supply control circuit for powering on the expansion portion in accordance with the detection of the establishment of communication by the detection circuit, wherein
the computer of the main device starts up the operating system by powering on the computer, and then performs recognition of the first communication device in the card slot, supplies power to the first communication device, and after a fixed wait time, performs recognition of the expansion portion provided in the peripheral device via the first communication device, the serial communication line, and the second communication device.

2. The data transmission equipment according to claim 1, wherein
the first communication device comprises:
a first bus interface circuit constituting an interface with the computer of the main device; and
a first serial/parallel interface circuit connected between the first bus interface circuit and the serial communication line, for performing parallel-to-serial conversion of transmitted data and performing serial-to-parallel conversion of received data, and
the second communication device comprises:
a second bus interface circuit constituting an interface with the expansion portion of the peripheral device; and
a second serial/parallel interface circuit connected between the serial communication line and the second bus interface circuit, for performing parallel-to-serial conversion of transmitted data and serial-to-parallel conversion of received data, wherein
the detection circuit is connected to the second serial-to-parallel interface circuit of the second communication device.

3. The data transmission equipment according to claim 1, wherein the first communication device of the main device and the second communication device of at least one peripheral device form a switch fabric bridge.
